(19) United States
(12) Patent Application Publication
(10) Pub. No.: US 2024/0062645 A1
(43) Pub. Date: Feb. 22, 2024

(54) PORTABLE ALARM SYSTEM

(71) Applicant: ArmorSiren, LLC, Palm Beach Gardens, FL (US)

(72) Inventors: Bruce DUBINSKY, Palm Beach Gardens, FL (US); Steve FISTER, Tucson, AZ (US)

(73) Assignee: ArmorSiren, LLC, Palm Beach Gardens, FL (US)

(21) Appl. No.: 18/199,891

(22) Filed: May 19, 2023

Related U.S. Application Data
(60) Provisional application No. 63/399,149, filed on Aug. 18, 2022.

(51) Int. Cl. G08B 25/00; G08B 25/01; G08B 25/12

(52) U.S. Cl. CPC G08B 25/008; G08B 25/016; G08B 25/12

(57) ABSTRACT

A portable alarm system to prevent theft. The portable alarm system includes multiple sensors to monitor tampering of an object or the surrounding area. The portal alarm can be attached to various objects and locations such as safes, doors, bikes, backpacks or other personal items. The portable alarm system plays a loud audible alarm when the sensors detect that an object or surrounding area has been tampered with.

### CROSS-REFERENCE TO RELATED APPLICATION

This application claims the benefit of U.S. Provisional Patent Application No. 63/399,149, filed Aug. 18, 2022, which is incorporated by reference herein in its entirety.

### GENERAL DESCRIPTION

The present disclosure relates to a portable alarm system. Specifically, a portable alarm system for use in a variety of different applications. For example, the alarm system may be employed to protect or alert any tampering or access to a safe, room (e.g., dormitory room, hotel room, apartment, closet door, storage shed). The alarm system can function as a personal safety device that is portable and deployed when the user is seeking additional security and protection.

Conventional safes, strongboxes, or other types of locked storage devices that are located in hotels and other similar locations only provide a minimum amount of security for personal and/or valuable items. These storage devices may contain master keys or override codes that can bypass the lock or security system of the storage device. These devices are also prone to theft from hotel staff. Additionally, hotel staff may also unlock room doors without permission or provide keycards to unauthorized persons. The vulnerabilities of safes and hotel rooms are also present in numerous other devices and structures. There are many other storage devices and lockable barriers that are susceptible to unauthorized access occurring. Thus, there is a demand for a system that provides an additional layer of safety for these locked storage devices and other locked objects or spaces that include a door, gate, hatch, panel, or movable barrier.

As described herein, a portable and personal alarm system is provided.

### BRIEF DESCRIPTION OF THE DRAWINGS

The features, aspects, and advantages of the invention will become apparent from the following description, and the accompanying exemplary embodiments shown in the drawings, which are briefly described below.

FIGS. 1a and 1b are front views of two different exemplary embodiments of an alarm system.

FIG. 2 is a deconstructed view of the exemplary alarm system of FIG. 1a.

FIG. 3 is a sectional side view of the exemplary alarm system of FIG. 1a.

FIG. 4 is a simplified section view of the exemplary alarm systems of FIGS. 1a and 1b.

FIG. 5a-5c is an isolated view of the top and bottom housing of the exemplary alarm system of FIG. 1b.

FIG. 6 is a simplified schematic of the exemplary alarm systems of FIGS. 1a and 1b.

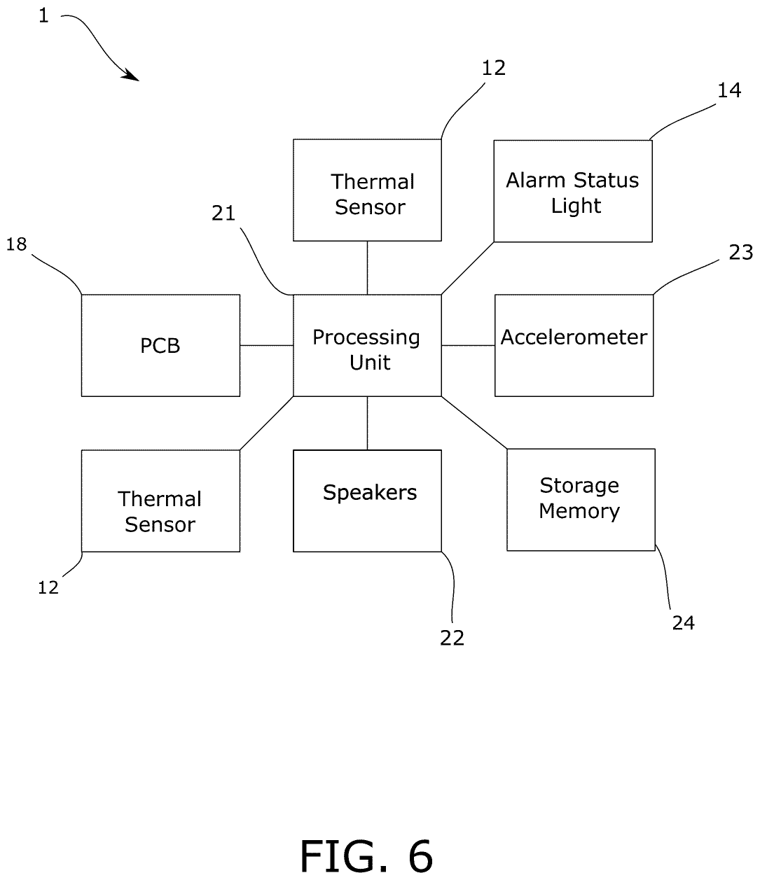

FIG. 7 is perspective view of the exemplary alarm system of FIG. 1a positioned to provide additional security and alarm protection for a safe.

FIG. 8 is a front view of the exemplary alarm system of FIG. 1a positioned to provide additional security and alarm protection for a door.

FIG. 9 is an isolated view of the exemplary alarm systems of FIGS. 1a and 1b with an auxiliary attachment device.

FIG. 10 is front view of the exemplary alarm system of FIG. 1a positioned to provide additional security and alarm protection for a storage device.

FIG. 11a-11d shows a exemplary cradle of the exemplary alarm systems of FIGS. 1a and 1b.

FIG. 11e shows an exemplary cradle used as a cover for the exemplary alarm system of FIG. 1b.

FIG. 12 is a basic flowchart showing operation of the exemplary alarm system of FIGS. 1 and 1b.

FIG. 13 is a basic flowchart showing operation of the exemplary alarm systems of FIGS. 1a and 1b.

FIG. 14 is a basic flowchart showing operation of the exemplary alarm systems of FIGS. 1a and 1b.

### DETAILED DESCRIPTION

An exemplary embodiment of an alarm system configured to be attached to an object such as a storage device or barrier is disclosed herein. The alarm system includes a housing, a processing unit, a keypad, a motion sensor and/or a thermal sensor, and a speaker. The keypad, motion sensor, and speaker are electrically connected to the processing unit. The processing unit, the keypad, the motion sensor, and the speaker are located within the housing. The keypad is configured to be operated to place the processing unit in an armed mode. In the armed mode, the processing unit is configured to monitor movement of the object by monitoring signals received from the motion sensor. If motion is detected, the motion sensor signals the processing unit to trigger the speaker during the armed mode. The motion sensor is preferably an accelerometer, but alternative sensors for detecting motion may be employed (e.g., a pressure sensor, a gyroscope, etc.)

According to another exemplary embodiment, a portable alarm system is disclosed that includes a housing having a first plate and a second plate opposite of the first plate. The alarm system also includes a keypad protruding through the first external face of the housing. An attachment mechanism is located on the second face configured to connect the housing to an external surface. The first plate is longer in length than the second plate so that the first plate may be configured to be used as a lever arm to aid in the removal of the attachment mechanism from the external surface.

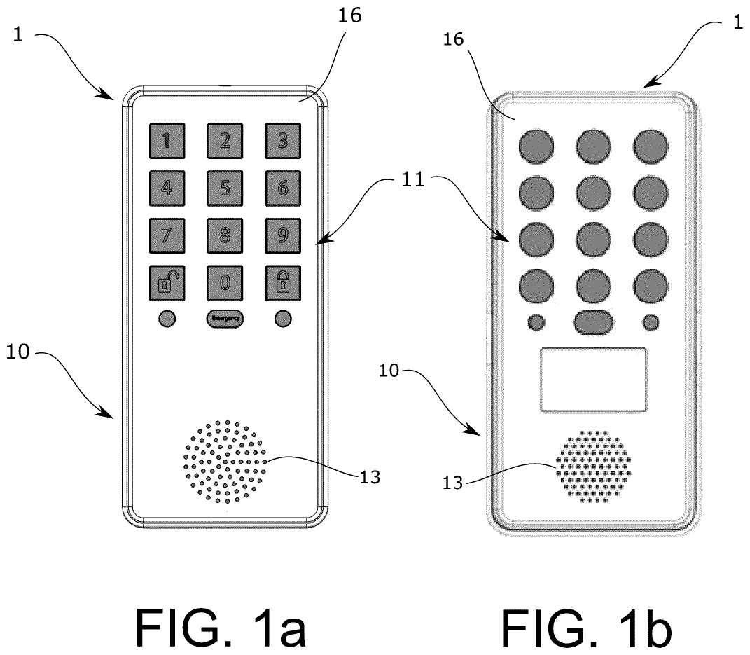

FIGS. 1a and 1b shows two embodiments of alarm system or device 1. The figures show a first side of an alarm system of alarm devices 1. The alarm system 1 includes a housing 10, a keypad 11, a thermal sensor 12 (within the housing). In some embodiments, the system may optionally include an optical sensor. The first side of housing 10 includes a first plate 16 and a second plate 17 (behind the first plate). The keypad 11 is located on the first plate 16 and may include one or more buttons that are labeled with digits zero through nine. The keypad may also include additional buttons that are labeled with commands or indicators other than numbers such as, blank, unlock and set alarm buttons. As described herein, the components of the two devices or systems shown in FIGS. 1a and 1b are essentially interchangeable. Thus, the operational, hardware and software features described herein may be implemented in either or both of the two embodiments depicted in FIGS. 1a and 1b.

The housing and all of the electronic components within the housing may be water resistant. The housing may additionally be made of impact and tamper resistant material. In some embodiments, an optical sensor status light or indicator may be configured to show the status of the optical sensor. For example, if the alarm system is set to record, a blinking red light may be shown that the optical sensor ready to record, and a solid red light may indicate that the optical sensor is recording. The alarm status light behind the transparent keypad shows the arm status of the alarm system 1. For example, if the alarm system 1 is armed, the alarm status light emit red light and when the alarm is ready to be armed, the alarm status light may emit green light.

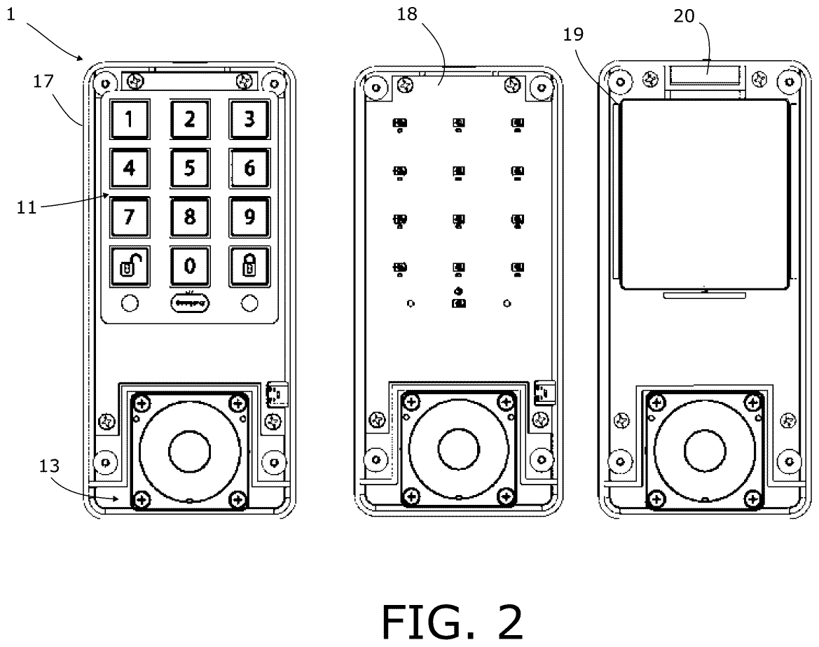

FIG. 2 shows a deconstructed assembly view of the alarm system 1 with the first plate 16 removed. The first plate 16 and the second plate 17 are removable from each other. A printed circuit board (PCB) 18 is secured within the housing. The PCB includes circuitry for providing functions selected on the keypad. The PCB may be connected to other components such as the speaker 13, the battery 19, and a main processing unit (not shown). A magnet 20 may be disposed within the upper portion of the alarm system. Additional magnets may be placed at other locations such as the bottom and/or the sides of the alarm system for greater holding power. The magnet 20 may be a neodymium magnet and be encased or protected by a Faraday shield so that magnetic interaction between the magnet and other electrical components of the alarm system is minimal.

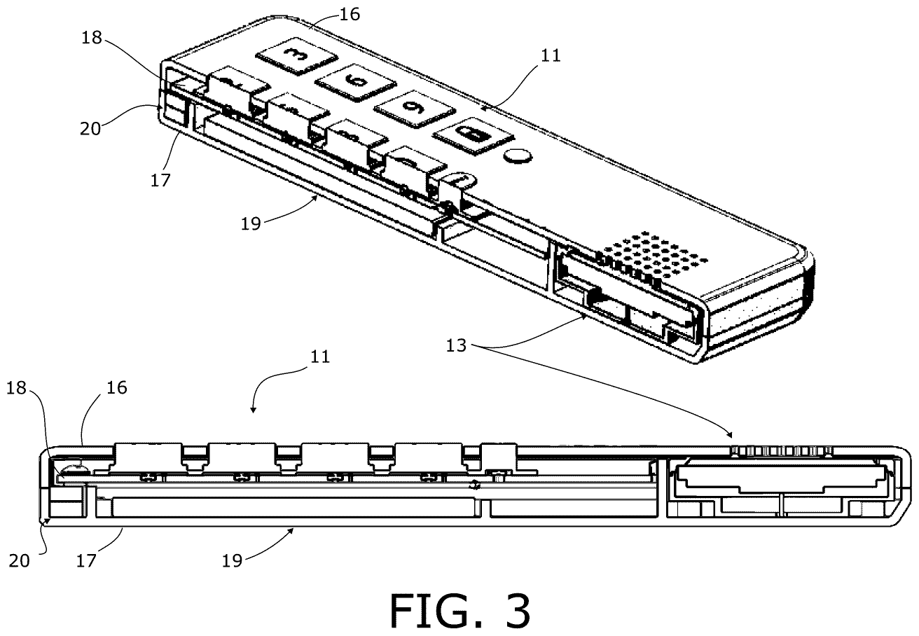

FIG. 3 shows sectional side view of the alarm system 1. The PCB may be fastened onto the second plate 17 by fasteners.

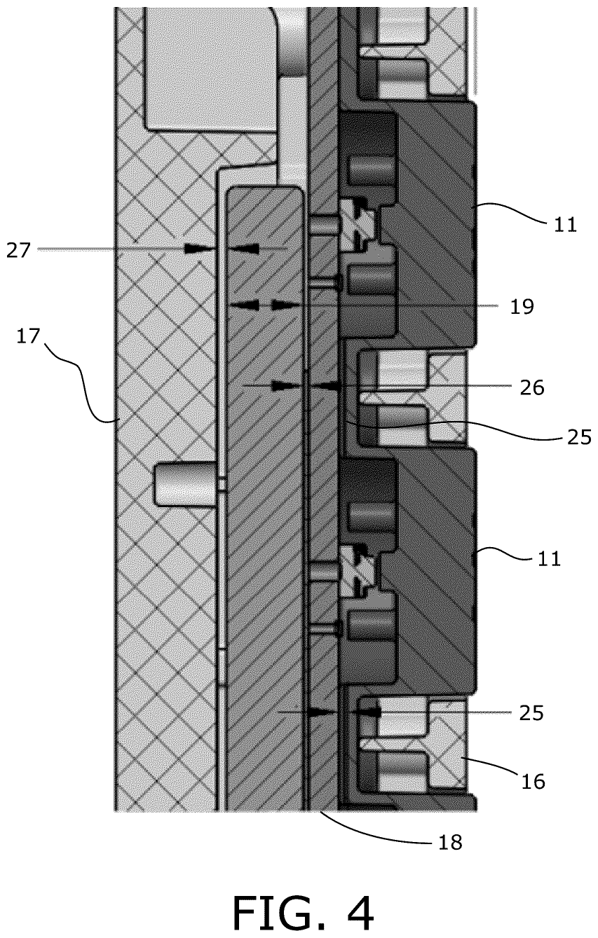

FIG. 4 shows a close up sectional view of the alarm system 1. The battery 19 may be spaced from the bottom housing 17 with gap 27. Tape 26 may be placed between the PCB 18 and the battery 19 to fasten the battery onto the PCB. Gap stabilizers may be placed between the PCB and the keypad 11 in order to structurally stiffen the alarm system 1 and prevent the keypad 11 from moving relative to the PCB 18.

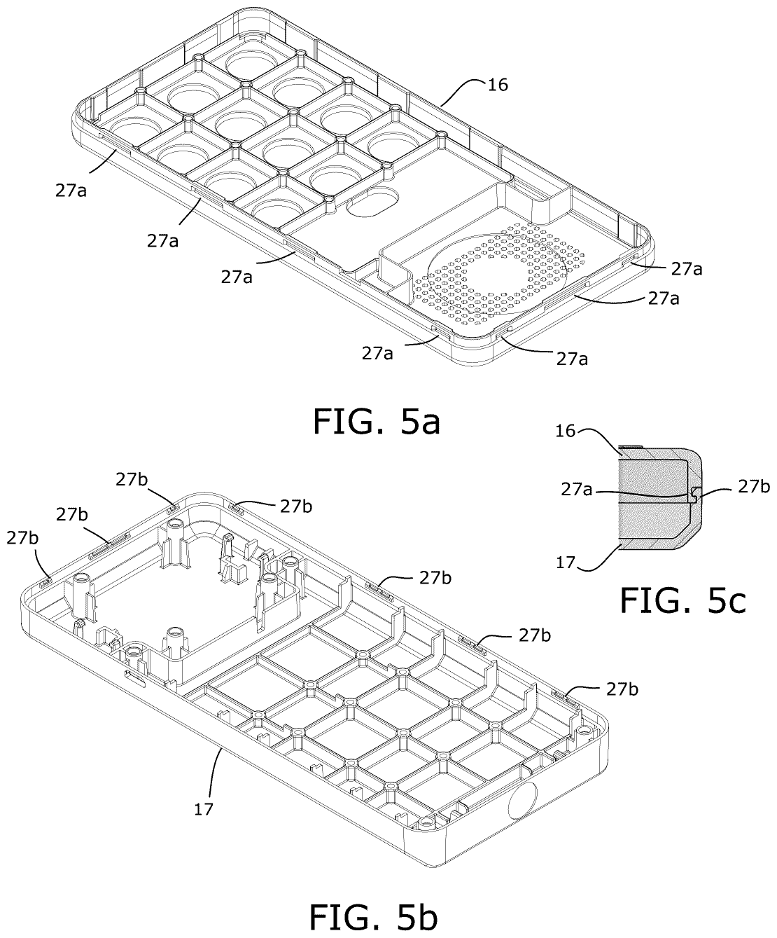

FIGS. 5a and 5b shows an alternative embodiment where the top and bottom housing are fastened to each other by a snap fit via the retaining clips 27a on the top housing 16 and retaining clips 27b on the bottom housing 17. The retaining clips 27a and 27b are configured to latch onto each other. Each of the male portions of the retaining clips 27a/27b are configured to latch onto each of the female portion of the opposing retaining clips 27b/27a located in the other housing. This allows the top housing 16 and bottom housing 17 to be closed onto each other.

FIG. 4 is a simplified schematic of the alarm system 1. The alarm system 1 includes a processing unit 21 that may include a microprocessor or CPU. The processing unit 21 is connected to the PCB 18, the speakers 22, the accelerometer 23, the battery 19, and the alarm status light 14. A storage memory unit 24 may be removable and connected to the processing unit. The storage memory unit 24 may save data from the optical sensor and may be accessed from an external electronic device (e.g. smart phone, laptop, computer, etc.) using any suitable and conventional wireless connection (e.g. Bluetooth, Wi-FI) via a phone app or a wired connection (e.g. MiniUSB/USB). The wired connection may also be used to charge the battery 19 of the alarm system 1. The app may control volume of siren, modify PIN codes, may have the ability to text to notify of an alarmed event to recipients (e.g. other users and emergency number 911). The App may also allow for sensitivity adjustments to the unit due to environmental surroundings.

The alarm system 1 employs the accelerometer 23 to detect movement of the alarm system and/or of the object the alarm system is attached to (e.g. a safe, door, etc.). The accelerometer 23 is preferably a variable capacitance accelerometer, but other accelerometers can be used (e.g., MEMS accelerometer). The alarm system 1 may be armed by operating the keypad 11. The processing unit may be programmable to accept one or more-digit codes (e.g. PIN code or arm code) to set the alarm system 1 into an arm mode. When the wrong code is entered a predetermined number of times (e.g., three times) the alarm system may be configured to be locked for a predetermined period of time (e.g., ten minutes). When armed, the processing unit 21 may monitor data from the accelerometer 23. Any movement above a predetermined threshold will trigger the processing unit to activate the speakers 22 until the arm code is entered or for a predetermined amount of alarm time (e.g. five minutes). The status lights 14 may be controlled by the processing unit to indicate the alarm is armed (i.e., illuminate the alarm status light 14). New arm codes may be set by the user by utilized a pre-programmed button on the keypad. The alarm system may also include a panic mode whereby the pushing of the special function key then a number (e.g. the number 1) then the arm button will immediately trigger the alarm. This way, the alarm system 1 maybe be used as a personal alarm device in case of attacks.

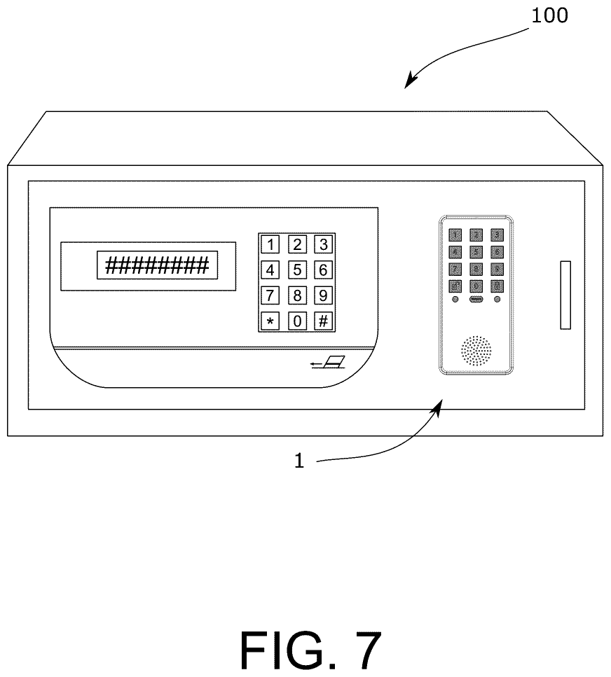

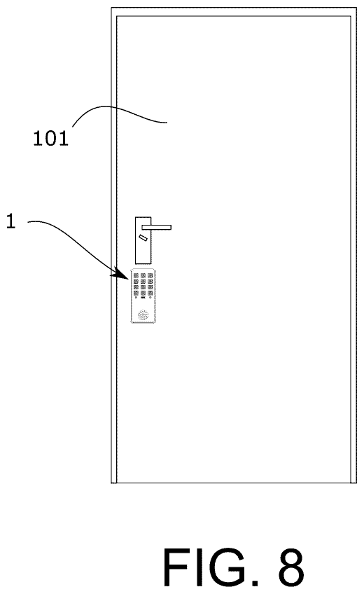

FIG. 7 depicts an exemplary use of the alarm system 1 on a safe 100. After the alarm system 1 is armed, by entering the appropriate PIN code, the door of the safe 100 may not be opened without first disarming the alarm system by entering the arm code on the keypad. If the safe door is opened while the alarm system 1 is still armed or if the alarm system is removed without disarming, the alarm system will trigger the speaker to emit a siren sound or other similar audible alert. Because the alarm system is attached to the safe 100, the entire safe cannot be moved without triggering the alarm system 1, when the system is armed. FIG. 8 is an exemplary use of the alarm system 1 on a door or barrier 101.

In one embodiment, there is a delay to enter the arming state and when the alarm will sound when triggered. This allows for users to arm or disarm the alarm system without unintentionally triggering the alarm. This delay may be a predetermined amount of time before the system fully arms or when the accelerometer no longer detects movement (e.g., sway) in the alarm system 1. There may also be a brief audible audio which is quitter than the main alarm, to indicate that alarm has been tripped, before providing the louder main alarm. The alarm system 1 may also have a limited number of attempts before the system is completely locked.

The alarm system may be activated by providing a signal to the processing unit using an application such as from a mobile device, a remote computer, or other electronic devices that can communicate with the alarm system 1 over a wired or wireless network (e.g., Bluetooth, Wi-Fi, Mobile Network). A mobile software application may be provided in order to allow the user to control the system from any of a number of devices such as, a phone, a tablet, a computer, etc.

The alarm system may further include a temperature sensor. The temperature sensor may monitor abrupt temperature changes in order to monitor further tampering methods. Abrupt changes in temperature above a predetermined amount may trigger the alarm system.

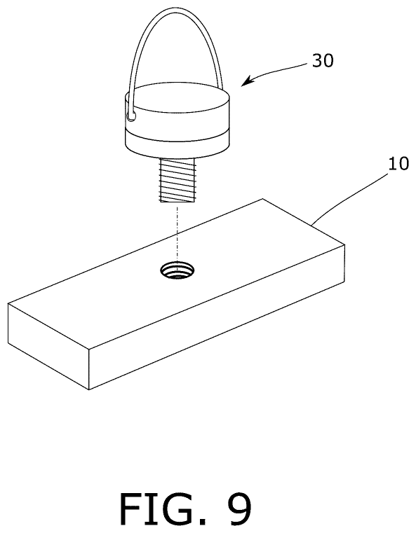

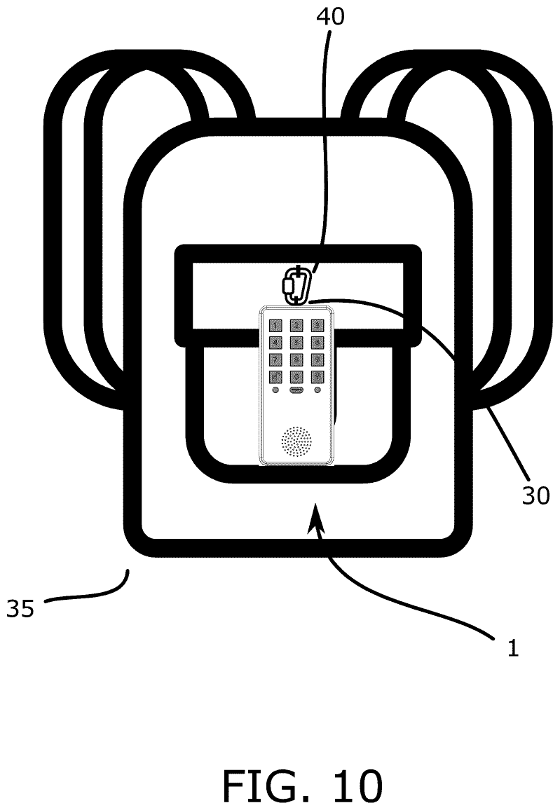

The alarm system 1 may include an auxiliary attachment device 30 as shown in FIG. 9. The alarm system 1 may also be used on luggage such as a backpack as shown in FIG. 10. In one embodiment, the auxiliary attachment device 30 may be a screw d-ring configured to be attached to the top of the alarm system 1. The screw d-ring may be directly fastened onto the housing using a thread and fastener interface. Other types of interfaces may be utilized. For example, the auxiliary attachment device may be attached by means of an adhesive, or the attachment may be accomplished using friction fitting, or by directly integrating the auxiliary device onto the housing. Alternatively, the magnet 20 may be used to attach the attachment device onto the alarm system 1. The auxiliary attachment device 30 may be located on either the first plate 16 or second plate 17. The auxiliary attachment device 30 may be configured to be attached to an additional structure such as locks, carabiners, lanyards, rope, etc. It should be known that the additional structures such as locks, carabiners, lanyards, rope, may also be structurally integrated to the attachment device 30 such that the additional structures are not removable from the attachment device 30. As shown in FIG. 10, a carabiner 40 may be attached to the auxiliary attachment device 30 and a storage device 35 such as a backpack. The alarm system 1 behaves similarly to the systems described above. After arming the alarm system 1 and placing the device on a piece of luggage or backpack any movement will trigger the alarm because movement is detected by the motion sensor (e.g., the accelerometer).

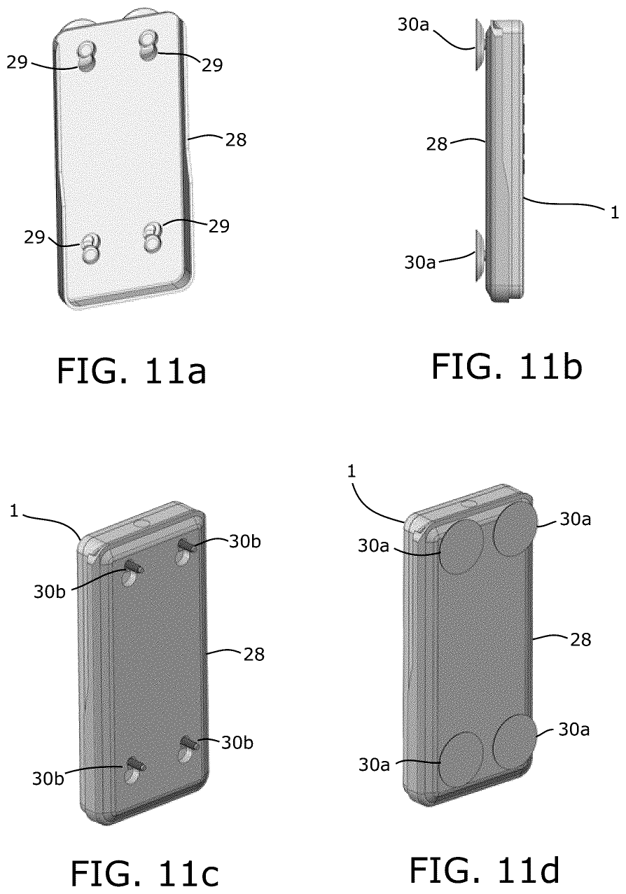

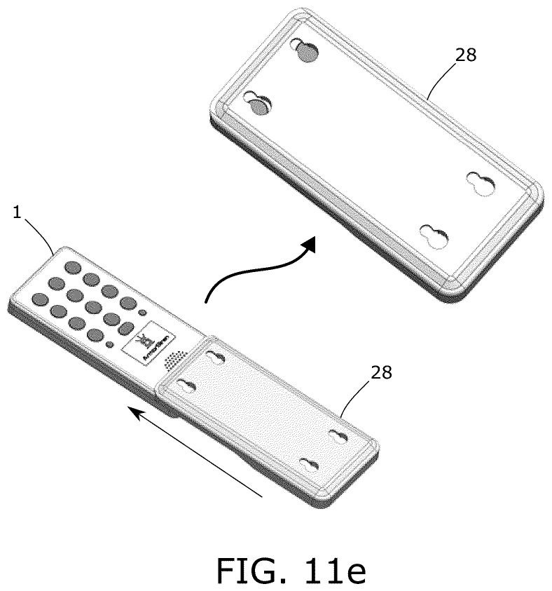

FIGS. 11a-11d shows an alternative embodiment of a mechanism to hold the alarm system 1. A cradle 28 may be provided with attachment points 29. These attachment points are specifically designed to serve as secure anchors for different mounting mechanisms, such as, a suction mount 30a or a fastening mount 30b. Suction mount 30a or fastening mount 30b may be attached to various objects and the selected mount may be utilized depending on the utilization of the alarm system 1. Suction mount 30a may be provided for a temporary application for the alarm system 1 while the fastening mount 30b may be used for a more permanent application. As shown in FIG. 11e the cradle 28 may also be used a cover for the keypad 11 when the alarm system 1 is not in use by reversing the alarm system 1 to face the cradle 28.

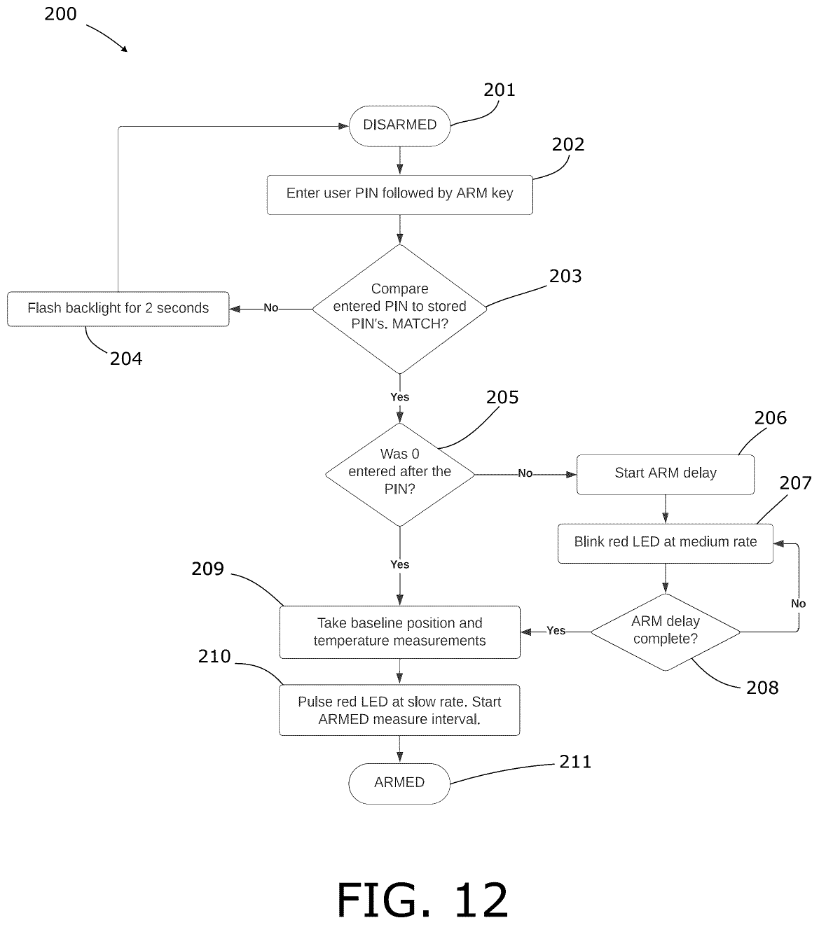

As shown in FIG. 12 a method of arming the alarm system 200 is shown. While in the disarmed state at step 201, a user is allowed to arm the alarm system at step 202 by entering a PIN or arm code. At step 203 the processing unit 21 authenticates the PIN code by comparing the entered PIN code to the PIN code stored in the memory unit 24 of alarm system. If the PIN codes do not match, then the alarm status lights 14 may flash at step 204 returning into the disarmed state at step 201. If the PIN codes match, then the processing unit 21 checks if an additional function button(s) on the keypad 11 was pressed after the PIN code (e.g., if 0 was entered after the PIN code was entered) at step 205. If no additional functions were pressed, then an arm time delay will proceed at step 206, and the alarm status light 14 will continue to blink at step 207 until the arm time delay check is complete at step 208. After the arm delay has been complete at step 208, then the processor will receive baseline sensor measurements from the accelerometer 23 and the temperature or thermal sensor 12 at step 209. After the baseline measurements from the sensors are received, then the alarm status light 14 will pulse slowly at step 210 and the alarm system 1 has reached its armed state at step 211.

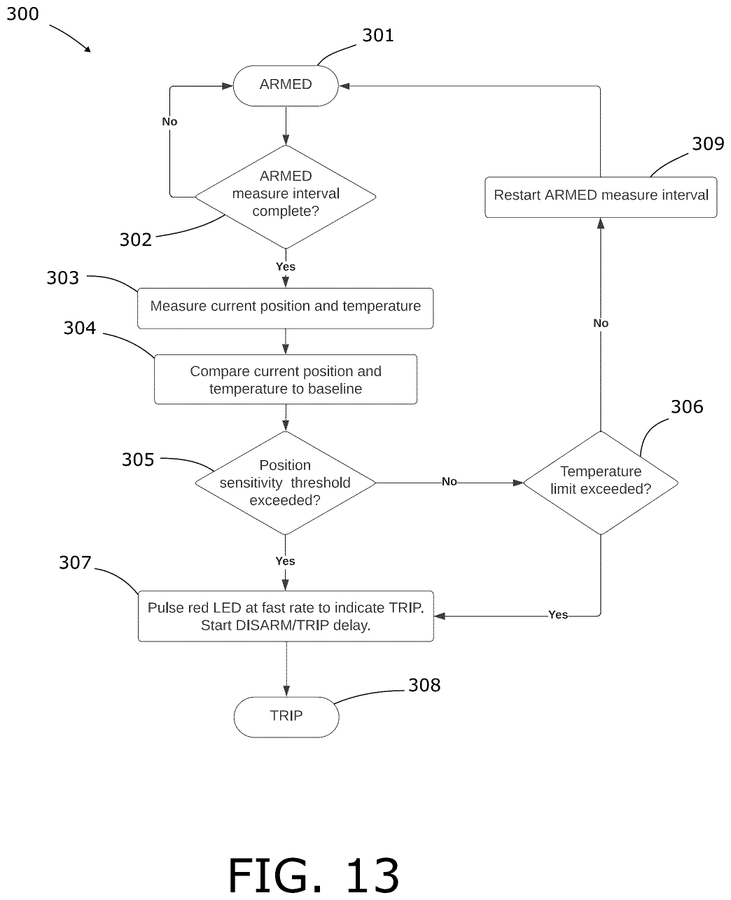

The armed configuration 300 is shown in FIG. 13. While in the armed state 301 the processor is continuously at predetermined time intervals at step 302, after a predetermined time interval has been passed, the sensors will measure the current position and temperature using the accelerometer 23 and thermal sensor 12 at step 303. Next, the values obtained by the sensors at step 303 are compared to the saved baseline measurement values from step 209 contained in the memory 24 at step 304. After the sensed or measured values are compared to the baseline measurement values, the processor 21 also checks if a positional sensitivity threshold is exceeded at step 305 by the measurement obtained by the accelerometer. If the positional sensitivity threshold is not exceeded, then the processor will check if a thermal sensitivity threshold is exceeded at step 306 based on the thermal sensor measurement. It should be noted that the sequence of steps 305 and 306 can be interchangeable or occur simultaneously. If the threshold is exceeded for either the accelerometer or thermal sensor, then the processor will begin pulsing the alarm status light 14 at a fast rate and begin a trip delay at step 307 and trip configuration at step 308 initiates. If the threshold has not been exceeded, then the processor will reset the timing of the predetermined interval at step 309 and continue monitoring the sensors after the set predetermined interval.

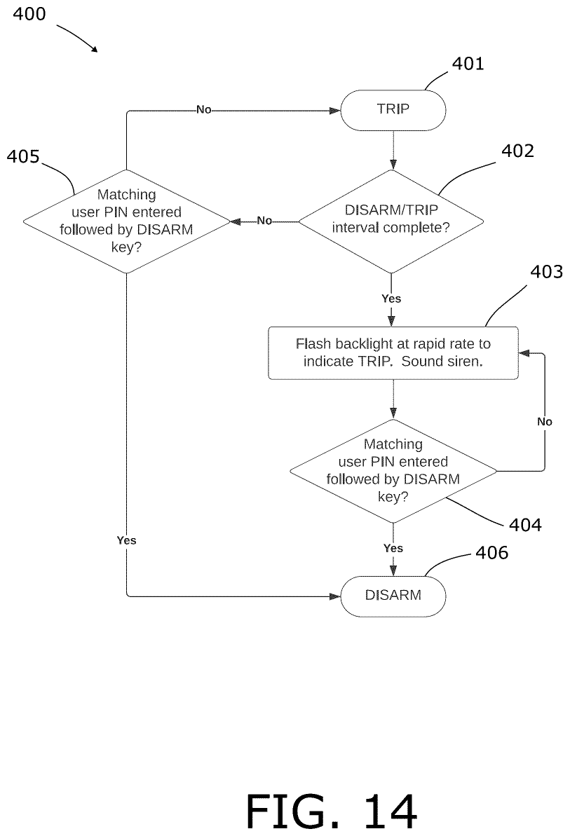

The trip configuration 400 is shown in FIG. 14. While in the trip state 401, the processor checks if the delay interval has been completed at step 402. If the delay is complete the alarm status light 14 will continue to flash rapidly and the processor will activate the speakers to emit a loud siren at step 403. The processor will continuously check for a matching input PIN code in conjunction with activation of the disarm function at step 404. If no matching PIN code and activation function has been entered, the status light 14 will continuously flash and the speaker will continuously play a loud siren. If a matching PIN code and disarm function is entered during the delay at step 405 or at the disarm check step 404, then the alarm system 1 will be fully disarmed by ceasing the rapid flashing of status light 14 and the loud siren from speaker 13 at step 406.

Any of the arming or disarming actions described above may be executed by the keypad 11 or remotely using an electronic device. Also, the keypad 11 may be omitted from the alarm system or device 1. The device may be controlled remotely by an electronic device (e.g. a smartphone or tablet).

Additionally, the alarm system 1 may include a GPS receiver (not shown) configured to receive signals from GPS satellites in order to track the device's location at all times. The GPS data may be transmitted via cellular communication or other types of communication such as the internet or satellite. The GPS capability allows the user to track the location of the alarm system 1 at all times.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the invention as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed:

1. A portable alarm system configured to be removably attached to an object, wherein the alarm system comprises:
a housing;
a processing unit;
a keypad;
an accelerometer;
a speaker;
wherein the processing unit, the keypad, the accelerometer, and the speaker are located within the housing,
wherein the processing unit is configured to place the system in an armed mode when the keypad is operated;
wherein the system is configured so that in the armed mode the processing unit is configured to monitor movement of the object using the accelerometer; and
wherein, in response to a signal received from the accelerometer, the processing unit is configured to cause the speaker to emit noise while the system is in the armed mode.

2. The alarm system of claim 1, further comprising an attachment device configured to facilitate attaching the alarm system to the object.

3. The alarm system of claim 2, wherein alarm system includes a GPS receiver.

4. The alarm system of claim 2, wherein the attachment device is a magnet disposed within the housing.

5. The alarm system of claim 2, wherein the attachment device is configured to be secured to the housing and the object.

6. The alarm system of claim 1, wherein when the processing unit is configured to place the system in the armed mode after a predetermined time delay has occurred following operating of the keypad.

7. The alarm system of claim 1, wherein the speaker is triggered by the processing unit after a predetermined time delay, wherein the triggering of the speaker is selectively canceled during the predetermined time delay after input of a PIN code on the keypad.

8. The alarm system of claim 1, wherein the processing unit is configured to receive a baseline measurement from the accelerometer before entering the armed mode.

9. A portable alarm system configured to be removably attached to an object, wherein the alarm system comprises:
a housing;
a processing unit;
a keypad;
a thermal sensor;
a speaker;
wherein the processing unit, the keypad, the thermal sensor, and the speaker are located within the housing;
wherein the keypad is operated to place the alarm system into an armed mode;
wherein, when the alarm system is in the armed mode, the processing unit is configured to receive a signal from the thermal sensor indicating a temperature change of an area surrounding portable alarm system; and
wherein the processing unit is configured to trigger the speaker in response to the signal received from the thermal sensor.

10. The alarm system of claim 9, further comprising an attachment device configured to attach the alarm system to the object.

11. The alarm system of claim 10, wherein the alarm system is configured to attach to a safe, a door, or a portable item.

12. The alarm system of claim 10, wherein the attachment device is a magnet disposed within the housing.

13. The alarm system of claim 10, wherein the attachment device is configured to be secured to the housing and the object.

14. The alarm system of claim 9, wherein when the armed mode is activated a predetermined amount of time after the keyboard has been operated.

15. The alarm system of claim 1, wherein the speaker is triggered by the processing unit after a predetermined time delay, wherein the triggering of the speaker is selectively canceled during the predetermined time delay due to the input of a PIN code on the keypad.

16. The alarm system of claim 1, wherein the processing unit is configured to receive a baseline measurement from the thermal sensor before entering the armed mode.

17. A portable alarm system configured to be removably attached to an object, wherein the alarm system comprises:
a housing;
a processing unit;
a keypad;
a motion sensor;
a thermal sensor;
a speaker;
a memory unit;
wherein each of the processing unit, the keypad, the motion sensor, the thermal sensor, and the speaker are located within the housing;
wherein the keypad is configured to signal the processing unit to place the system into an armed mode after input of a PIN code on the keypad, wherein the PIN code is stored within the memory unit;
wherein, when in the armed mode, the processing unit is configured to detect movement of the object using a signal received the motion sensor and temperature changes of an area surrounding portable alarm system using a signal received from the thermal sensor; and
wherein at least one of the motion sensor and the thermal sensor communicates to the processing unit to cause the speaker to emit an audible alarm during the armed mode.

18. The portable alarm system of claim 17, wherein the processing unit is configured to place the alarm system in the armed mode when the PIN code is entered into the keypad and authenticated using the stored PIN code and after a first predetermined time delay.

19. The alarm system of claim 18, wherein the speaker is triggered by the processing unit after a second predetermined time delay, wherein the triggering of the speaker is selectively canceled during the second predetermined time delay in response to the input of the PIN code.

20. The alarm system of claim 17,
wherein the processing unit is configured to receive a motion sensor baseline data and a thermal sensor baseline data and store both of the baseline data within the memory unit before entering the armed mode; and
wherein, during the armed mode, the processing unit is configured to continuously compare current measured sensor data from the motion sensor and the thermal sensor to the accelerometer baseline data and the thermal sensor baseline data, respectively, so that when the current sensor data from the accelerometer and the thermal sensor exceeds a predetermined threshold, the processing unit triggers the speaker to emit the audible alarm.
